(19) United States
(12) Patent Application Publication
(10) Pub. No.: US 2018/0161963 A1
(43) Pub. Date: Jun. 14, 2018

(54) Strain Device Tool

(71) Applicant: Steven Thomas Winchester, Covington, GA (US)

(72) Inventor: Steven Thomas Winchester, Covington, GA (US)

(21) Appl. No.: 15/330,452

(22) Filed: Dec. 12, 2016

(51) Int. Cl. B25B 7/02; B25B 7/06

(52) U.S. Cl. CPC B25B 7/02; B25B 7/06

(57) ABSTRACT

The present invention provides a hand tool for enabling an individual to change the height of a traffic intersection light. The hand tool comprises a pair of elongated members with a handle end, jaw end, and a pivot joint, whereby the elongated members are hingedly connected. One jaw member has a distal curved pointed end and the other jaw member has an upper flat end. In use, the curved pointed jaw member is inserted into a height adjuster device to unlock it from a cable. Once unlocked, a technician can selectively reposition an attached traffic intersection light. The hand tool keeps the height adjuster device unlocked because the jaws are spring biased away from each other. Overall, the device that can assist with altering the height of a traffic light.

### BACKGROUND:

This invention relates to improvements for enabling an individual to change the height of a traffic intersection light. Changing the height of a traffic light can be a stressful process. A technician typically has to use a screwdriver to unlock a height adjuster device that securely suspends the traffic light. Often, this process is completed in an awkward position which could lead to injury and cramps. The technician may then end up dropping materials on a busy street below and become frustrated. The pressure of getting this job done on a timely manner can be overwhelming for some professionals. There exists a need for a device that can assist with altering the height of a traffic light.

Devices are known in the prior art that relate to clamping-type devices. They generally relate to clamping-type devices comprising a lock opening pliers with a distal end for supporting a plunger or bolt. These devices, however, fail to provide a device for changing the height of a traffic light, wherein the device includes a pair of elongated members with a handle end, jaw end, and a pivot joint. Further, these devices fail to provide the same whereby one jaw member has a distal curved pointed end and the other jaw member has an upper flat end. Such features, however, are provided by the presented invention.

### SUMMARY

A high percentage of traffic intersections are hung in the air with span wire attached to poles at the four corners of the intersection. The span wire itself is seven pieces of steel braided into one circular strand and is ⅜ inches in diameter. On a typical intersection it takes eight separate pieces of span wire and sixteen strain devices to erect an intersection. The ends of the span wire are connected by strain devices. A strain device is a locking mechanism in which the span wire is inserted through the strain device (usually around eighteen inches). Then the strain device automatically locks around the span wire, which holds the weight of traffic signals; street signs and the electrical wiring needed for functionality.

The manner in which erecting the intersection and components is to install the span wire relativity high first, so when the weight of the traffic signals, street signs, and electrical wire are complete, then the whole intersection can be raised or lowered to meet the local D.O.T. height specifications. This is when the “Strain Device Tool” is employed.

The conventional (old) way of unlocking a strain device is to insert a thin flat head screwdriver into the small slot (keyhole) of the strain device and unlock it by squeezing the screwdriver towards the top of the strain device. This method of holding open the locking mechanism is very strenuous on the individual and can result in hand cuts or cramps. Also, while one hand is holding the strain device open (unlocked), it only leaves one other hand to make the necessary adjustments.

The “Strain Device Tool” is necessary because once this tool is employed, it holds the strain device open while the individual makes the proper adjustments while being able to use both hands. With that being said, there isn't another such tool that can do this until now.

### DESCRIPTION OF INVENTION

Referring now to FIGS. 1-2, there is a perspective view and a close-up view of the hand tool for enabling an individual to change the height of a traffic intersection light. The hand tool comprises a pair of elongated members with a handle end, jaw end, and a pivot joint, whereby the elongated members are hingedly connected. In addition, a retention mechanism extends from the elongated handle. In the shown embodiment, the retention mechanism is a chain and D-link that is configured to attach to a fixed object.

A jaw member is disposed at the jaw end (distal end of the elongated member), and faces an opposing jaw member disposed on the other elongated member. A first jaw member has a distal curved pointed end and the second jaw member has an upper flat end. A spring mechanism causes the jaw to be spring biased away from each other. In a preferred embodiment, a spring is disposed between the two elongated members and configured to bias the jaw members away from each other. In this way, the movement of the handle ends towards each other causes the jaws to move away from the opposing jaw. Movement of the handle ends away each other causes the jaws to move towards the opposing jaw.

Referring now to FIGS. 3 and 4, there is a perspective view of the hand tool for enabling an individual to change the height of a traffic intersection light inserted into a height adjuster device and an illustrative view of the hand tool for enabling an individual to change the height of a traffic intersection light. A height adjuster device is utilized to suspend a traffic intersection light from a cable. The height adjuster device includes a locking mechanism that couples the height adjuster device to a cable. The present invention is specifically designed to unlock the height adjuster device and enable an individual to change the height of a traffic intersection light by repositioning the height adjuster device along the cable. In operation, the jaw with the distal curved pointed end is inserted into a recessed area in the height adjuster device that unlocks the connection between the height adjuster device and the cable. The jaw member with upper flat end is positioned substantially flush with the top of the height adjuster device. The present invention keeps the height adjuster device unlocked because the jaws are spring biased away from each other. The height of the traffic intersection light can be selectively adjusted, and when the hand tool is removed, the height adjuster device locks to the cable.

The foregoing descriptions of specific embodiments of the present invention have been presented for purposes of illustration and description. They are not intended to be exhaustive or to limit the present invention to the precise forms disclosed, and obviously many modifications and variation are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

### BRIEF DESCRIPTION OF FIGURES:

FIG. 1 shows a perspective view of the hand tool for enabling an individual to change the height of a traffic intersection light.

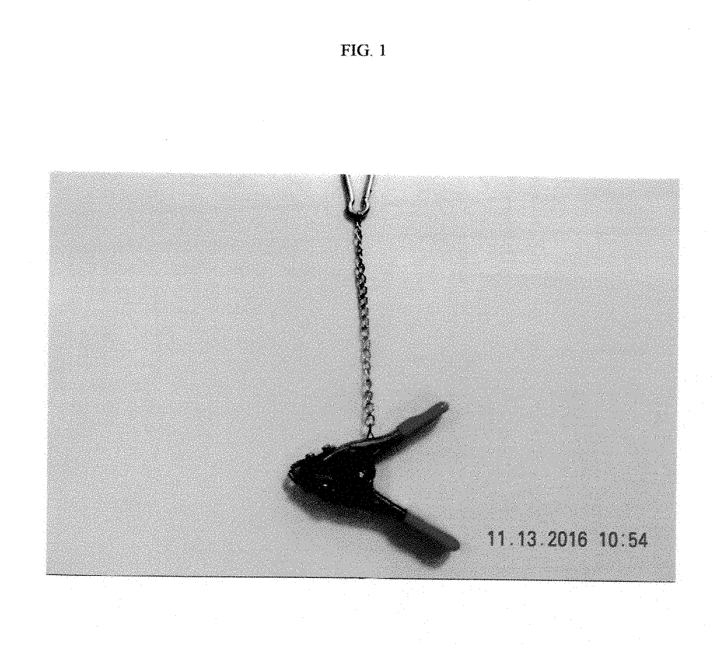

FIG. 2 shows a close-up view of the jaws of the hand tool for enabling an individual to change the height of a traffic intersection light. One end (jaw member) has a distal curve pointed end. The other end (jaw member) has an upper flat end.

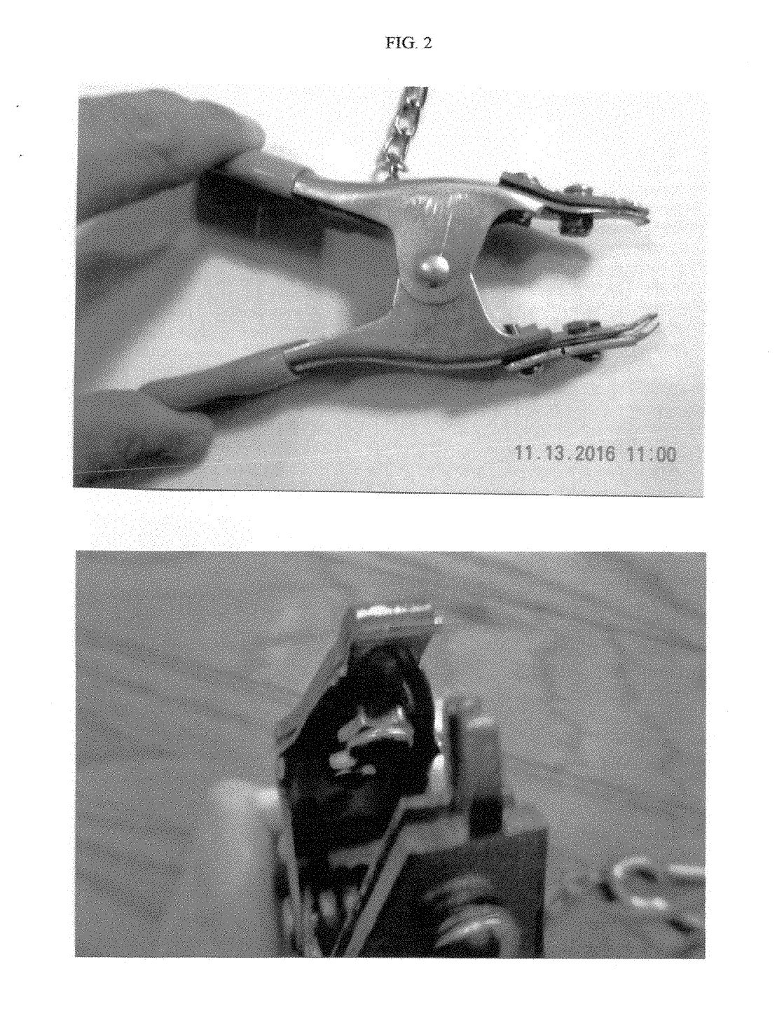

FIG. 3 shows a perspective view of the hand tool for enabling an individual to change the height of a traffic intersection light inserted into a height adjuster device.

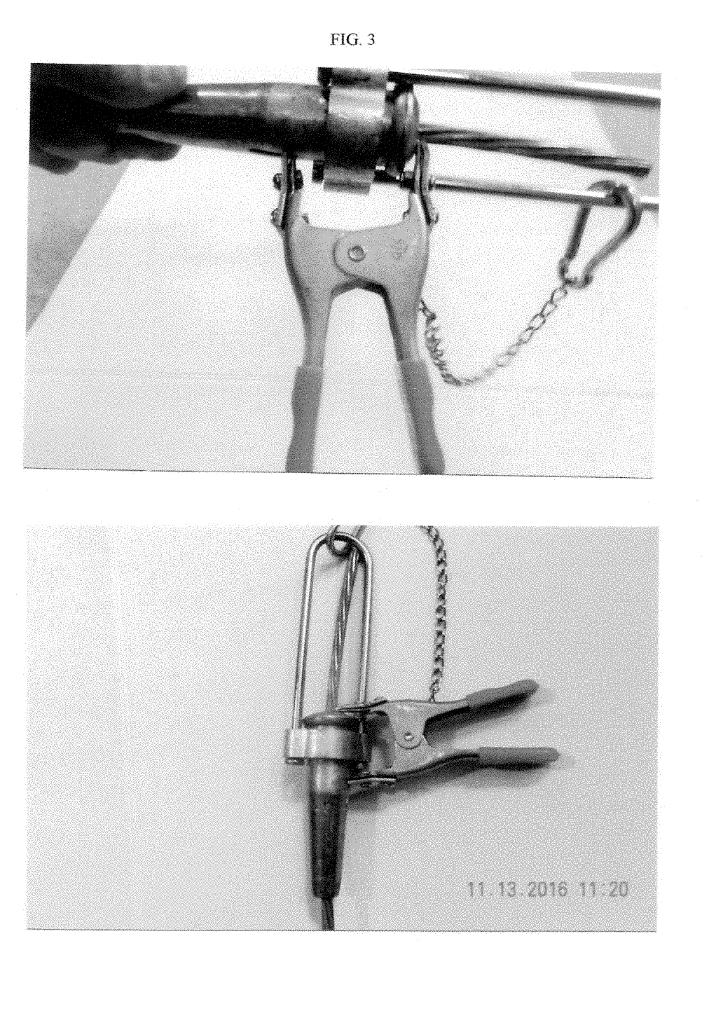

FIG. 4 shows an illustrative view of the hand tool tor enabling an individual to change the height of a traffic intersection light.

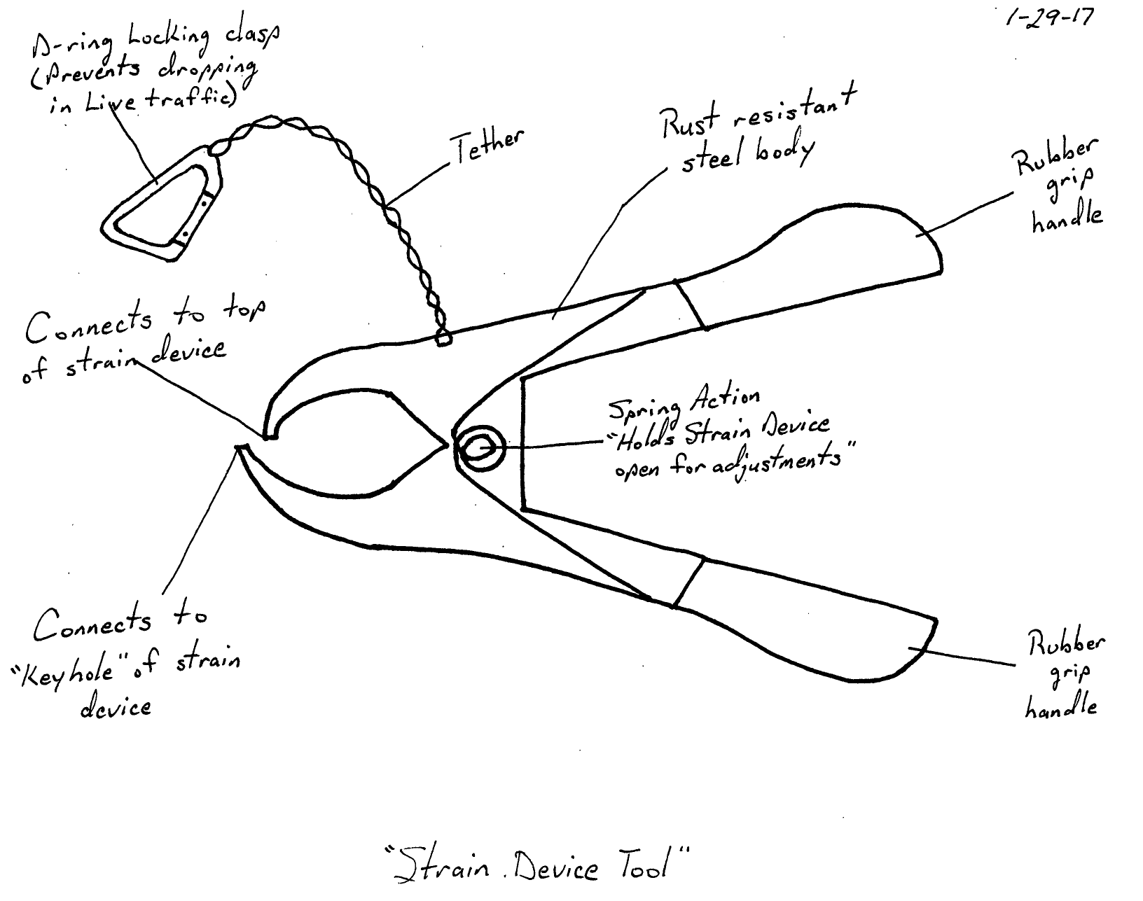

### DETAILED DESCRIPTION OF THE INVENTION

The tool comprises a pair of elongated members with a handle end, jaw end, and a pivot joint, (spring) whereby the elongated members are connected.

The lower jaw member has a distal curve and is precisely then to insert into the locking mechanism (keyhole) of the strain device and the upper jaw member has a leveled flat end to rest atop the strain device.

In use, when the Strain Device Tool handles are squeezed together and the lower jaw is inserted into the keyhole of the strain device and the upper jaw is rested atop the strain devices correctly, as the tool is released, the spring action engages and holds the strain device open and unlocked. This allows the technician to use both hands to make the necessary adjustments rather than one hand occupied under stress trying to hold the strain device open, thus only having one hand to make adjustments.

1. The claimed invention is the jaw ends. Upper jaw end is flat, but beveled to fit the top of the strain device. The lower jaw has a distal curved end that is precisely cut to fit into the “keyhole” of the strain device.
